(19) United States
(12) Patent Application Publication
(10) Pub. No.: US 2026/0336603 A1
(43) Pub. Date: Oct. 29, 2026

(54) AUTONOMOUS PARKING CONTROL DEVICE AND METHOD THEREOF

(71) Applicant: HYUNDAI MOBIS CO., LTD., Seoul (KR)

(72) Inventor: Seung Hyun KIM, Yongin-si (KR)

(73) Assignee: HYUNDAI MOBIS CO., LTD., Seoul (KR)

(21) Appl. No.: 19/642,989

(22) Filed: Apr. 9, 2026

(30) Foreign Application Priority Data
Apr. 23, 2025 (KR) 10-2025-0053292

(51) Int. Cl. B60W 30/06; B60W 60/00

(52) U.S. Cl. CPC B60W 30/06; B60W 60/001; B60W 2540/22; B60W 2540/221; B60W 2540/229; B60W 2555/20

(57) ABSTRACT

The present disclosure relates to autonomous parking control, and more particularly, to a device implemented to control autonomous parking by reflecting data related to a driver and environment data related to a vehicle, and a method thereof. An autonomous parking control device according to an embodiment of the present disclosure is a device implemented to control autonomous parking of a vehicle, the device comprising: a main controller implemented to output a control command for autonomous parking of the vehicle based on sensor data provided in relation to the vehicle and a pre-stored initial control parameter; and sub-controllers implemented to perform autonomous parking of the vehicle based on the control command of the main controller, wherein the main controller may be implemented to change the initial control parameter based on a weight determined from the sensor data.

### CROSS-REFERENCE TO THE RELATED APPLICATION

This application claims priority to and benefit under 35 USC § 119(a) of Korean Patent Application No. 10-2025-0053292 filed on Apr. 23, 2025, in the Korean Intellectual Property Office, the disclosure of which is incorporated herein by reference in its entirety for all purposes.

### BACKGROUND

### 1. Field

The present disclosure relates to autonomous parking control, and more particularly, to a device implemented to control autonomous parking by reflecting data related to a driver and environment data related to a vehicle, and a method thereof.

### 2. Description of the Related Art

An autonomous parking function is implemented to search for a parking space based on predefined rules and algorithms, and to automatically park a vehicle without driver intervention, and is being applied to vehicles in order to provide convenience to a driver.

Because a conventional autonomous parking function is implemented based on rule-based development, it cannot reflect various environments around a vehicle. In addition, because the conventional autonomous parking function depends on structured data, it cannot reflect unstructured data such as a driver’s parking habit preference, and thus utility is low.

Therefore, a method capable of improving utility of an autonomous parking function is required.

The matters described as the background art above are for enhancement of understanding of the background of the present disclosure, and should not be taken as an acknowledgment that they correspond to prior art already known to those of ordinary skill in the art.

### SUMMARY

An embodiment of the present disclosure has a technical object to provide an autonomous parking control device implemented to perform autonomous parking control by reflecting driver-related data, and a method thereof.

An embodiment of the present disclosure has a technical object to provide an autonomous parking control device implemented to perform autonomous parking control by reflecting an external environment of a vehicle, and a method thereof.

Technical objects to be achieved in the present disclosure are not limited to the technical objects mentioned above, and other technical objects not mentioned will be clearly understood by those of ordinary skill in the art to which the present disclosure belongs from the description below.

In one general aspect, an autonomous parking control device for a vehicle includes a main controller configured to output a control command for autonomous parking of the vehicle based on sensor data provided in relation to the vehicle and a pre-stored initial control parameter; and one or more sub-controllers configured to perform autonomous parking of the vehicle in response to the control command from the main controller, wherein the main controller is configured to change the initial control parameter based on a weight determined from the sensor data.

The main controller may be further configured to output the control command based on a modified control parameter in which the initial control parameter has been changed by the main controller.

The sensor data may include vehicle data, driver data, and environment data.

The main controller may be configured to output the control command based on the initial control parameter corresponding to the vehicle data and the environment data.

The main controller may be further configured to determine a driver weight based on the driver data and an environment weight based on the environment data.

The main controller may be further configured to determine a congestion index and a weather index around the vehicle based on the environment data, and to determine the environment weight based on the congestion index and the weather index.

The main controller may be further configured to determine the environment weight based on traffic volume statistical information corresponding to vehicle position data and time data of the environment data.

The driver data may include driver behavior data, driver personal data, and driver biometric data.

The main controller may be further configured to determine a driver attention index based on the driver behavior data; determine a driver biometric index based on the driver biometric data; and determine the driver weight based on the driver attention index, the driver biometric index, and traffic accident statistical information and motor ability statistical information corresponding to the driver personal data.

In one general aspect, an autonomous parking control method, performed by a device that controls autonomous parking of a vehicle, includes receiving, by a main controller of the device, sensor data related to the vehicle; outputting, by the main controller, an initial control command for autonomous parking based on the sensor data and a pre-stored initial control parameter; performing, by one or more sub-controllers of the device, autonomous parking based on the initial control command; changing, by the main controller, the initial control parameter based on a weight determined from the sensor data; and outputting, by the main controller, a second control command for autonomous parking based on the sensor data and a modified control parameter in which the initial control parameter has been changed.

Specific matters according to various examples of the present disclosure other than the means for solving the problems mentioned above are included in the description below and the drawings.

According to an embodiment of the present disclosure, an autonomous parking control device implemented to perform autonomous parking control by reflecting driver-related data, and a method thereof may be provided.

According to an embodiment of the present disclosure, an autonomous parking control device implemented to perform autonomous parking control by reflecting an external environment of a vehicle, and a method thereof may be provided.

When autonomous parking is controlled using the autonomous parking control device and method thereof according to an embodiment of the present disclosure, a customized autonomous parking service for a driver can be provided.

In addition, because unstructured data is reflected, accuracy of autonomous parking can be improved, and utility of autonomous parking and driver satisfaction can be improved.

Effects obtainable from the present disclosure are not limited to the effects mentioned above, and other effects not mentioned will be clearly understood by those of ordinary skill in the art to which the present disclosure belongs from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing a vehicle 1 having an autonomous parking control device 100 according to an embodiment of the present disclosure;

FIG. 2 is a diagram showing an example of a configuration of an autonomous parking control device 100 according to an embodiment of the present disclosure;

FIG. 3 is a diagram showing an example of a configuration of a main controller 110 according to an embodiment of the present disclosure;

FIG. 4 is a diagram showing an example of a configuration of a processor 117 according to an embodiment of the present disclosure; and

FIG. 5 is a diagram for explaining an autonomous parking control method according to an embodiment of the present disclosure.

### DETAILED DESCRIPTION

In describing the embodiments disclosed in the present specification, if it is determined that a detailed description of related known technologies may obscure the gist of the embodiments disclosed in the present specification, the detailed description thereof will be omitted. In addition, the accompanying drawings are only for easy understanding of the embodiments disclosed in the present specification, and it should be understood that the technical idea disclosed in the present specification is not limited by the accompanying drawings, and includes all changes, equivalents, and substitutes included in the spirit and technical scope of the present disclosure.

Terms including ordinal numbers such as first, second, etc. may be used to describe various components, but the components are not limited by the terms. The terms are used only for the purpose of distinguishing one component from another component.

Singular expressions include plural expressions unless the context clearly indicates otherwise.

In the present specification, terms such as “comprise” or “have” are intended to designate that a feature, number, step, operation, component, part, or combination thereof described in the specification exists, and should be understood as not excluding in advance the existence or possibility of addition of one or more other features, numbers, steps, operations, components, parts, or combinations thereof.

The suffixes “module” and “unit” for components used in the following description are given or used interchangeably only in consideration of ease of specification preparation, and do not have meanings or roles that are distinguished from each other.

When it is mentioned that a component is “connected” or “contacted” to another component, it should be understood that it may be directly connected or contacted to the other component, but another component may exist in between. On the other hand, when it is mentioned that a component is “directly connected” or “directly contacted” to another component, it should be understood that another component does not exist in between.

Hereinafter, embodiments disclosed in the present specification will be described in detail with reference to the accompanying drawings, but the same or similar components will be given the same reference numbers regardless of drawing symbols, and redundant descriptions thereof will be omitted.

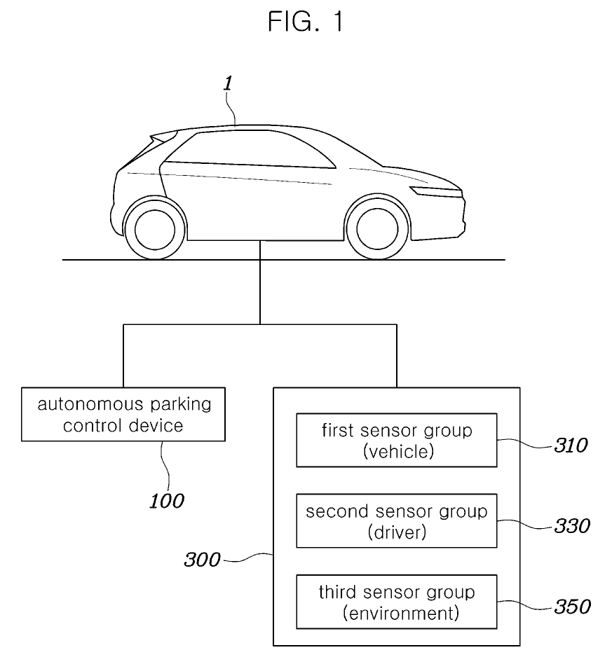

FIG. 1 is a diagram showing a vehicle 1 having an autonomous parking control device 100 according to an embodiment of the present disclosure.

Referring to FIG. 1, vehicle 1 comprises an autonomous parking control device 100, and may comprise a sensor group 300 that acquires and provides data necessary for operation of autonomous parking control device 100.

For example, vehicle 1 may be a vehicle implemented to be capable of autonomous driving, autonomous parking, etc., and may be an eco-friendly vehicle such as an Electric Vehicle (EV), a Hybrid Electric Vehicle (HEV), a Plug-in Hybrid Electric Vehicle (PHEV), or a Fuel Cell Electric Vehicle (FCEV).

According to an embodiment, autonomous parking control device 100 can control autonomous parking of vehicle 1 based on data provided from sensor group 300.

For example, autonomous parking control device 100 and sensor group 300 can perform communication based on a vehicle network. For example, the vehicle network may comprise Local Interconnect Network (LIN), Controller Area Network (CAN), FlexRay, Media Oriented System Transport (MOST), Ethernet, etc.

Configuration and operation (or function) of autonomous parking control device 100 will be described later.

According to an embodiment, sensor group 300 may comprise a first sensor group 310 that acquires vehicle 1 related data (hereinafter, vehicle data) and provides the acquired vehicle data to autonomous parking control device 100.

For example, first sensor group 310 can acquire data related to a state of vehicle 1 (hereinafter, vehicle state data). For example, first sensor group 310 may comprise a speed sensor, an acceleration sensor, a yaw rate sensor, a steering angle sensor, a Global Positioning System (GPS) sensor, etc., and the type of sensor included in first sensor group 310 is not limited thereto.

For example, first sensor group 310 can acquire data related to specifications of vehicle 1 (hereinafter, vehicle specification data). For example, vehicle specification data may comprise overall length, height, tread, wheelbase, minimum turning radius, etc.

According to an embodiment, sensor group 300 may comprise a second sensor group 330 that acquires driver related data (hereinafter, driver data) and provides the acquired driver data to autonomous parking control device 100.

According to an embodiment, second sensor group 330 can acquire data related to behavior of a driver (hereinafter, driver behavior data).

For example, second sensor group 330 may comprise a driver monitoring system. For example, second sensor group 330 may comprise a plurality of sensors capable of acquiring data related to behavior of a driver, such as a camera that photographs a driver face, a sensor that detects grasping of a steering wheel by a driver, a sensor that recognizes a driver eye, etc.

According to an embodiment, second sensor group 330 can acquire data related to personal information of a driver (hereinafter, driver personal data).

For example, second sensor group 330 can acquire driver gender, driver age, etc. For example, second sensor group 330 may comprise a sensor that is connected based on short-range communication (ex, Bluetooth) with a mobile terminal (ex, smartphone, etc.) or a smart wearable device of a driver, and collects driver personal data from the mobile terminal or the smart wearable device.

According to an embodiment, second sensor group 330 can acquire data related to biometric information of a driver (hereinafter, driver biometric data).

For example, second sensor group 330 may comprise a biometric sensor that measures driver biometric data (ex, brain waves, heart rate, etc.). For example, the biometric sensor may be installed on a driver seat. For example, second sensor group 330 may comprise a sensor that is connected with a smart wearable device of a driver based on short-range communication (ex, Bluetooth), and collects driver biometric data from the smart wearable device.

According to an embodiment, sensor group 300 may comprise a third sensor group 350 that acquires data related to a surrounding environment of vehicle 1 (hereinafter, environment data) and provides the acquired environment data to autonomous parking control device 100.

For example, third sensor group 350 may comprise a navigation, a camera, a radar sensor, a lidar sensor, an ultrasonic sensor, an external temperature sensor, a rain sensor, etc., and the type of sensor included in third sensor group 350 is not limited thereto.

For example, the navigation can provide position data, time data, etc. of vehicle 1. For example, the camera, the radar sensor, the lidar sensor, and the ultrasonic sensor can provide a result of detecting an object (ex, vehicle, obstacle, etc.) around vehicle 1. For example, the external temperature sensor can provide an external temperature of vehicle 1. For example, the rain sensor can measure and provide an amount of rain.

Hereinafter, autonomous parking control device 100 and a method thereof according to an embodiment of the present disclosure will be described more specifically.

Autonomous parking control device 100 according to an embodiment can control autonomous parking based on data provided from sensor group 300 (hereinafter, sensor data).

Autonomous parking control device 100 can control autonomous parking based on vehicle data provided from first sensor group 310, driver data provided from second sensor group 330, and environment data provided from third sensor group 350.

According to an embodiment, autonomous parking control device 100 can control autonomous parking based on a preset autonomous parking control algorithm initially in autonomous parking.

Here, the autonomous parking control algorithm may be an algorithm for controlling autonomous parking based on a control parameter set based on vehicle data (initial control parameter).

According to an embodiment, autonomous parking control device 100 can change the initial control parameter based on driver data provided from second sensor group 330, and control autonomous parking based on the changed control parameter.

For example, autonomous parking control device 100 can determine a driver weight based on driver data, and change the initial control parameter based on the determined driver weight.

According to an embodiment, autonomous parking control device 100 can change the initial control parameter based on environment data provided from third sensor group 350, and control autonomous parking based on the changed control parameter.

For example, autonomous parking control device 100 can determine an environment weight based on environment data, and change the initial control parameter based on the determined environment weight.

According to an embodiment, autonomous parking control device 100 can change maximum vehicle speed, an acceleration parameter, a deceleration parameter, a steering variation, a suspension damping amount, an obstacle recognition distance parameter, etc. of vehicle 1 based on driver data and environment data, and the parameter changed by autonomous parking control device 100 is not limited thereto.

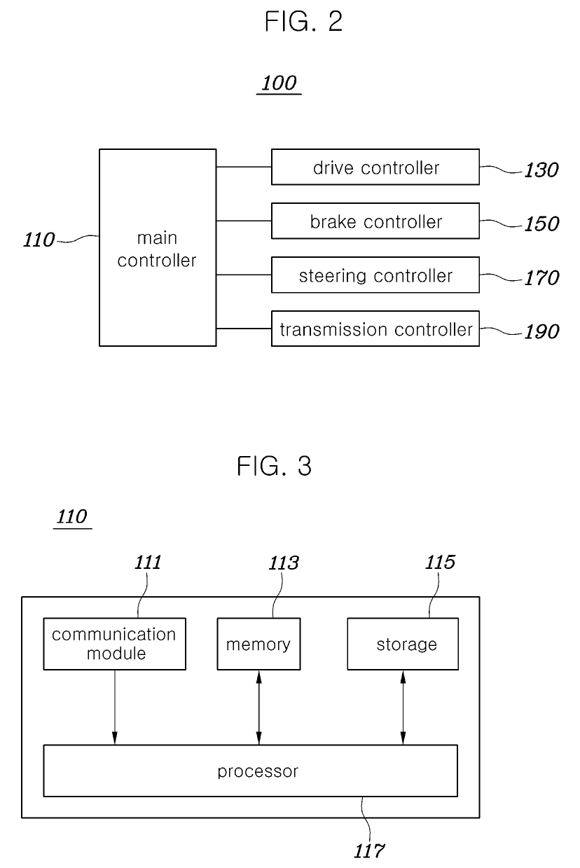

FIG. 2 is a diagram showing an example of a configuration of autonomous parking control device 100 according to an embodiment of the present disclosure.

Referring to FIG. 2, autonomous parking control device 100 may comprise a main controller 110, and sub-controllers operating according to control of main controller 110. For example, the sub-controllers may comprise a drive controller 130, a brake controller 150, a steering controller 170, and a transmission controller 190.

Main controller 110 can control autonomous parking for vehicle 1 based on sensor data provided from sensor group 300.

Main controller 110 can control autonomous parking for vehicle 1 overall, and can output a command according to a parking situation to sub-controllers 130, 150, 170, 190.

Main controller 110 can control sub-controllers 130, 150, 170, 190 based on a preset autonomous parking control algorithm initially in autonomous parking.

According to an embodiment, main controller 110 can control sub-controllers 130, 150, 170, 190 based on an initial control parameter according to the autonomous parking control algorithm initially in autonomous parking.

According to an embodiment, main controller 110 can change the initial control parameter based on driver data provided from second sensor group 330, and control sub-controllers 130, 150, 170, 190 based on the changed control parameter.

According to an embodiment, main controller 110 can change the initial control parameter based on environment data provided from third sensor group 350, and control sub-controllers 130, 150, 170, 190 based on the changed control parameter.

Drive controller 130, brake controller 150, steering controller 170, and transmission controller 190 may be implemented as an Electronic Control Unit (ECU).

For example, the electronic control unit may comprise a memory that stores software programmed to perform predetermined functions (operations) and a processor that executes the software stored in the memory.

Drive controller 130 can control a power source (ex: engine and/or drive motor, etc.) of vehicle 1. Drive controller 130 can control output (ex: output torque) of the power source according to accelerator pedal position information or a driving speed requested from main controller 110. For example, drive controller 130 may comprise an Engine Management System (EMS) and/or a Motor Control Unit (MCU), etc.

Brake controller 150 is for controlling deceleration (braking) of vehicle 1, and can control braking force of vehicle 1 based on a brake pedal position or required braking force of main controller 110. For example, brake controller 150 may comprise Electronic Stability Control (ESC), etc.

Steering controller 170 controls steering of vehicle 1, and may comprise Motor Drive Power Steering (MDPS), etc. Steering controller 170 can adjust a steering angle of vehicle 1 according to an instruction of main controller 110.

Transmission controller 190 can control a transmission of vehicle 1 according to an instruction of main controller 110. Transmission controller 190 can adjust a gear ratio according to a gear position and/or a gear state range. For example, transmission controller 190 may comprise a Transmission Control Unit (TCU), etc.

FIG. 3 is a diagram showing an example of a configuration of main controller 110 according to an embodiment of the present disclosure.

Referring to FIG. 3, main controller 110 may comprise a communication module 111, a memory 113, a storage 115, and a processor 117.

Communication module 111 may comprise a communication circuit implemented to communicate with sensor group 300, and a communication circuit implemented to communicate with sub-controllers 130, 150, 170, 190.

Data input to communication module 111 can be stored in memory 113, can be stored in storage 115, and can be transmitted to processor 117.

For example, communication module 111 may be implemented to perform communication based on a vehicle network such as Local Interconnect Network (LIN), Controller Area Network (CAN), FlexRay, Media Oriented System Transport (MOST), Ethernet, etc.

Memory 113 can store an algorithm (or software or program), data, etc. necessary for autonomous parking control of main controller 110.

Storage 115 can store data generated or acquired according to operation of main controller 110. For example, storage 115 can store data that main controller 110 receives from sensor group 300, data received from sub-controllers 130, 150, 170, 190, etc.

For example, memory 113 and storage 115 may be implemented as at least one or more storage media among flash memory, hard disk, Secure Digital Card (SD Card), Random Access Memory (RAM), Static Random Access Memory (SRAM), Read Only Memory (ROM), Programmable Read Only Memory (PROM), Electrically Erasable and Programmable ROM (EEPROM), Erasable and Programmable ROM (EPROM), register, removable disk, web storage, etc.

Processor 117 can perform overall operation of main controller 110.

According to an embodiment, processor 117 can perform autonomous parking control for vehicle 1 based on data received through communication module 111, algorithms/data stored in memory 113, data stored in storage 115, etc.

For this purpose, processor 117 may be a data processing device implemented as hardware having a circuit having a physical structure for executing desired operations. For example, the desired operations may comprise code or instructions included in a program. For example, the data processing device implemented as hardware may comprise a microprocessor, a central processing unit, a processor core, a multi-core processor, a multiprocessor, an Application-Specific Integrated Circuit (ASIC), a Field Programmable Gate Array (FPGA), etc.

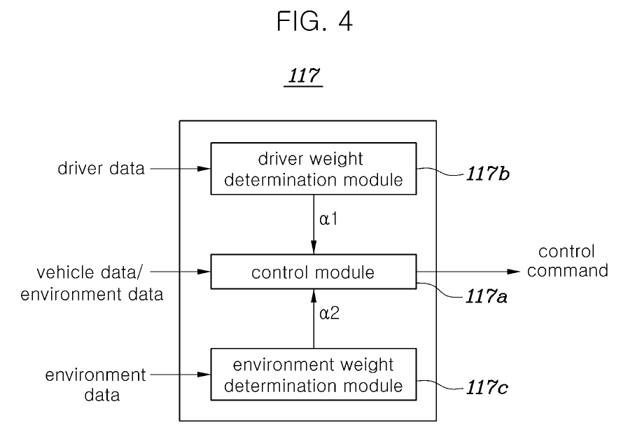

FIG. 4 is a diagram showing an example of a configuration of processor 117 according to an embodiment of the present disclosure.

Referring to FIG. 4, processor 117 may comprise a control module 117a, a driver weight determination module 117b, and an environment weight determination module 117c.

Control module 117a can control autonomous parking based on a preset autonomous parking control algorithm initially in autonomous parking control.

For example, control module 117a can control autonomous parking based on the autonomous parking control algorithm stored in memory 113.

According to an embodiment, control module 117a can output a control command according to the autonomous parking control algorithm and the initial control parameter based on vehicle data and environment data initially in autonomous parking control.

According to an embodiment, control module 117a can change the initial control parameter based on a driver weight α₁ determined by driver weight determination module 117b, and output a control command based on the changed control parameter.

For example, control module 117a can change the initial control parameter based on a driver control parameter map comprising a control parameter for each driver weight α₁.

According to an embodiment, control module 117a can change the initial control parameter based on an environment weight α₂ determined by environment weight determination module 117c, and output a control command based on the changed control parameter.

For example, control module 117a can change the initial control parameter based on an environment control parameter map comprising a control parameter for each environment weight α₂.

According to an embodiment, control module 117a can change the initial control parameter based on driver weight α₁ determined by driver weight determination module 117b and environment weight α₂ determined by environment weight determination module 117c, and output a control command based on the changed control parameter.

For example, control module 117a can change the initial control parameter based on a driver-environment control parameter map comprising a control parameter for each driver-environment weight α₁-α₂.

For example, the driver control parameter map, the environment control parameter map, and the driver-environment control parameter map can be stored in memory 113.

According to an embodiment, driver weight determination module 117b can determine driver weight α₁ based on driver data.

For example, driver weight determination module 117b can determine driver weight α₁ based on driver behavior data, driver personal data, and driver biometric data.

For example, driver weight determination module 117b can determine a driver attention index based on driver behavior data, and determine driver weight α₁ based on the driver attention index.

For example, driver weight determination module 117b can determine driver weight α₁based on driver personal data and statistical information for each personal data.

For example, driver weight determination module 117b can determine a driver weight based on traffic accident statistical information corresponding to driver gender. For example, driver weight determination module 117b can determine driver weight α₁ based on motor ability statistical information corresponding to driver age.

For example, driver weight determination module 117b can determine a driver biometric index based on driver biometric data, and determine driver weight α₁ based on the driver biometric index.

According to an embodiment, environment weight determination module 117c can determine environment weight α₂ based on environment data.

For example, environment weight determination module 117c can determine a congestion index around vehicle 1 based on environment data, and determine environment weight α₂ based on the congestion index.

For example, environment weight determination module 117c can determine a weather index based on environment data, and determine environment weight α₂ based on traffic accident statistical information corresponding to weather.

For example, environment weight determination module 117c can determine environment weight α₂ based on traffic volume statistical information corresponding to vehicle position data and time data of the environment data.

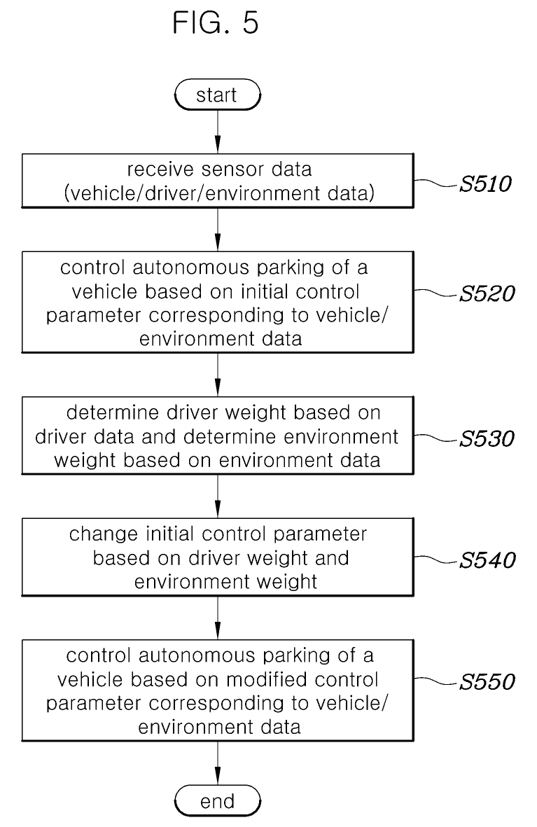

FIG. 5 is a diagram for explaining an autonomous parking control method according to an embodiment of the present disclosure.

Referring to FIG. 5, autonomous parking control device 100 can receive sensor data from sensor group 300 during autonomous parking control for vehicle 1 in step S510.

According to an embodiment, the sensor data may comprise vehicle data, driver data, and environment data.

Thereafter, autonomous parking control device 100 can control autonomous parking of vehicle 1 based on vehicle data and environment data in step S520.

According to an embodiment, main controller 110 can output a control command based on the initial control parameter corresponding to vehicle data and environment data, and sub-controllers 130, 150, 170, 190 can perform autonomous parking based on the control command.

Thereafter, autonomous parking control device 100 can determine driver weight α₁ based on driver data, and determine environment weight α₂ based on environment data in step S530.

In the present embodiment, although it is exemplified that autonomous parking control device 100 determines both driver weight α₁ and environment weight α₂, only one of driver weight α₁ and environment weight α₂ may be determined.

Thereafter, autonomous parking control device 100 can change the initial control parameter based on driver weight α₁ and environment weight α₂ in step S540.

According to an embodiment, autonomous parking control device 100 can change the initial control parameter based on a driver control parameter map comprising a control parameter for each driver weight α₁.

According to an embodiment, autonomous parking control device 100 can change the initial control parameter based on an environment control parameter map comprising a control parameter for each environment weight α₂.

According to an embodiment, autonomous parking control device 100 can change the initial control parameter based on a driver-environment control parameter map comprising a control parameter for each driver-environment weight α₁-α₂.

Thereafter, autonomous parking control device 100 can control autonomous parking of vehicle 1 based on a modified control parameter corresponding to vehicle data and environment data in step S550.

Although embodiments of the present disclosure have been described in more detail with reference to the accompanying drawings above, the present disclosure is not necessarily limited to these embodiments, and can be variously modified and implemented within a scope not departing from the technical spirit of the present disclosure. Therefore, the embodiments disclosed in the present specification are not for limiting the technical spirit of the present disclosure but for explaining it, and the scope of the technical spirit of the present disclosure is not limited by these embodiments. Therefore, it should be understood that the embodiments described above are illustrative in all respects and not restrictive. The protection scope of the present disclosure should be interpreted by the claims, and all technical spirits within the equivalent scope thereof should be interpreted as being included in the scope of rights of the present disclosure.

What is claimed is:

1. An autonomous parking control device for a vehicle, the device comprising: a main controller configured to output a control command for autonomous parking of the vehicle based on sensor data provided in relation to the vehicle and a pre-stored initial control parameter; and
one or more sub-controllers configured to perform autonomous parking of the vehicle in response to the control command from the main controller, wherein the main controller is configured to change the initial control parameter based on a weight determined from the sensor data.

2. The device of claim 1, wherein the main controller is further configured to output the control command based on a modified control parameter in which the initial control parameter has been changed by the main controller.

3. The device of claim 1, wherein the sensor data comprises vehicle data, driver data, and environment data.

4. The device of claim 3, wherein the main controller is configured to output the control command based on the initial control parameter corresponding to the vehicle data and the environment data.

5. The device of claim 3, wherein the main controller is further configured to determine a driver weight based on the driver data and an environment weight based on the environment data.

6. The device of claim 5, wherein the main controller is further configured to determine a congestion index and a weather index around the vehicle based on the environment data, and to determine the environment weight based on the congestion index and the weather index.

7. The device of claim 5, wherein the main controller is further configured to determine the environment weight based on traffic volume statistical information corresponding to vehicle position data and time data of the environment data.

8. The device of claim 5, wherein the driver data comprises driver behavior data, driver personal data, and driver biometric data.

9. The device of claim 8, wherein the main controller is further configured to:
determine a driver attention index based on the driver behavior data;
determine a driver biometric index based on the driver biometric data; and
determine the driver weight based on the driver attention index, the driver biometric index, and traffic accident statistical information and motor ability statistical information corresponding to the driver personal data.

10. An autonomous parking control method performed by a device that controls autonomous parking of a vehicle, the method comprising:
receiving, by a main controller of the device, sensor data related to the vehicle;
outputting, by the main controller, an initial control command for autonomous parking based on the sensor data and a pre-stored initial control parameter;
performing, by one or more sub-controllers of the device, autonomous parking based on the initial control command;
changing, by the main controller, the initial control parameter based on a weight determined from the sensor data; and
outputting, by the main controller, a second control command for autonomous parking based on the sensor data and a modified control parameter in which the initial control parameter has been changed.

11. The method of claim 10, wherein the changing of the initial control parameter further comprises:
determining a driver weight based on driver behavior data and driver biometric data; and
determining an environment weight based on a congestion index and a weather index around the vehicle.

12. The method of claim 10, further comprising performing communication between the main controller and the one or more sub-controllers via a vehicle network comprising at least one of a Controller Area Network (CAN), FlexRay, and Ethernet.

13. The device of claim 1, wherein the main controller is configured to change the initial control parameter by selecting a specific control parameter from a pre-stored control parameter map based on the determined weight, the control parameter map comprising at least one of a driver control parameter map, an environment control parameter map, and a driver-environment control parameter map.

14. The device of claim 5, wherein the main controller is configured to determine the driver weight by correlating driver gender and driver age from the driver data with traffic accident statistical information and motor ability statistical information, respectively.
